(19) United States
(12) Patent Application Publication
(10) Pub. No.: US 2005/0076183 A1
(43) Pub. Date: Apr. 7, 2005

(54) Method and apparatus for enforcing timed agreements

(75) Inventors: Alexander Medvinsky, San Diego, CA (US); Eric Sprunk, Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation, Horsham, PA (US)

(21) Appl. No.: 10/796,340

(22) Filed: Mar. 9, 2004

Related U.S. Application Data
(60) Provisional application No. 60/509,508, filed on Oct. 7, 2003.

(51) Int. Cl. G06F 12/14

(52) U.S. Cl. 711/163

(57) ABSTRACT

A system is provided for enforcing program content agreements between a program distributor and a client. The program content can be restricted so as to prevent any playback of program content once unauthorized interference is detected. Furthermore, a specific time value can be used as part of a time message to indicate an expiration of a time stamp. Thus, an attack using fabricated time messages or buffered time messages can be averted.

### CROSS-REFERENCES TO RELATED APPLICATIONS

This application claims the benefit of U.S. provisional application entitled “Method and Apparatus for Enforcing Timed Agreements”, filed Oct. 7, 2003 which is hereby incorporated herein by reference in its entirety for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

Embodiments of this invention relate generally to enforcement of time restrictions. For example, one embodiment of the invention relates to enforcing digital rights rental agreements.

### BACKGROUND

With the advent of distribution of digital information via networks, it is now possible to rent digital works, such as digital video programming. A digital rental agreement can be used to outline how long a user is entitled to view a program or how many times a program can be viewed. Some programming is intended to be downloaded and played immediately. This allows a portion of the program to be downloaded and played immediately while the remaining portion is downloaded during the playback of the original portion.

Multicasting program material to a number of viewers allows a wide audience to be served. Usually, this comes at the cost of a reduction in interactivity between the viewers and the program distributor. However, like other broadcast mediums such as television and radio, it permits a large audience to receive program material at the same time.

Some programming is so valuable that a distributor will want to limit the amount of time that it can be viewed or the number of repetitions that can be viewed. One way to accomplish this restriction is to impose a rental agreement on the content. By implementing rules of the rental agreement, the client computer is limited as to how the content can be viewed or listened to. Thus, for example, a client might be limited to viewing content for only a fixed period of time.

Some people will try to avoid these restrictions. As a result, authentication measures need to be imposed to protect the commercial value of the content and enforce the agreed upon rules.

### SUMMARY

One embodiment of the invention provides a method of controlling use of program content. This method can be accomplished by receiving program content; storing the program content in memory; storing a rule for whether the program content in memory may be played; receiving a first time out message operable for use with the rule, wherein the first time out message comprises a time out limit indicating a time of day by which an update message must be received; and enforcing the rule by disabling playback of the program content in memory.

Another embodiment of the invention provides an apparatus for controlling use of program content. The apparatus is comprised of a receiver operable for receiving the program content from a processor coupled with memory for storing program content and code operable for implementing a rule for determining whether the program content in memory may be played.

Yet another embodiment of the invention provides a method of controlling use of program content. The method can be comprised of receiving program content from a content distribution server; storing the program content in memory at a client computer; storing a digital rights management rule for determining whether the program content in memory may be played by the client; receiving a first time message, the first time message comprising a system time of day value and an expiration time of day value; determining a current time of day; comparing the current time of day to the expiration time of day; checking for a second time message, wherein the second time message comprises a second system time of day value and a second expiration time of day value; and code operable for disabling playback of the program content if the second time message is not received prior to the current time of day.

A further embodiment of the invention provides an apparatus for controlling use of program content. The apparatus can be comprised of a receiver for receiving program content from a content distribution server; memory for storing the program content; code operable for determining a current time of day; code operable for comparing the current time of day to an expiration time of day value received in a first time message, the first time message comprising the expiration time of day value in a system time; code operable for checking for a second time message, the second time message comprising a second system time of day value and a second expiration time of day value; and code operable for disabling playback of the program content if the second time message is not received prior to the current time of day.

### BRIEF DESCRIPTION OF THE DRAWINGS

FIG. 1 illustrates a flowchart demonstrating a method of restricting use of program content, according to one embodiment of the invention.

FIG. 2 illustrates a block diagram of an exemplary computer system for implementing one embodiment of the invention.

FIGS. 3A, 3B, and 3C illustrate a flowchart for enforcing a digital rights agreement, according to one embodiment of the invention.

FIGS. 4A and 4B illustrate a flowchart for implementing a method of disabling playback of program content if a time restriction is violated, according to one embodiment of the invention.

FIGS. 5A, 5B, and 5C illustrate a flowchart for implementing a method of restricting playback of program content, according to one embodiment of the invention.

FIG. 6 illustrates an exemplary system for distributing program content to a client system, according to one embodiment of the invention.

FIG. 7 illustrates an example of a first time message downloaded to a client system, according to one embodiment of the invention.

FIG. 8 illustrates a second time message downloaded to a client system according to one embodiment of the invention.

### DETAILED DESCRIPTION

As noted earlier, a program distributor will often enter into an agreement with a content receiver, such as that between a cable distributor and a home customer for distributing video programming. The agreement sets forth how the program content can be used. With the advent of digital works and content that can be distributed over various networks, such as the Internet, it is now possible to provide a great many works for use by customers. To ensure that these digitals works are viewed according to the program content agreement, a time stamp can be provided for use in enforcing a time-based agreement.

An attacker may try to circumvent this time stamp system by creating a delay in the client clock so as to delay detection of the time limit by the client's computer. Thus, by delaying or slowing down the hardware or software-based clock a client provides, the hacker can enjoy the content for a longer period of time. Furthermore, even when the time limit is detected by the client computer, the hacker can continue to enjoy program content that has already been downloaded. Thus the hacker is only deprived of that content which has not yet been downloaded to the client computer.

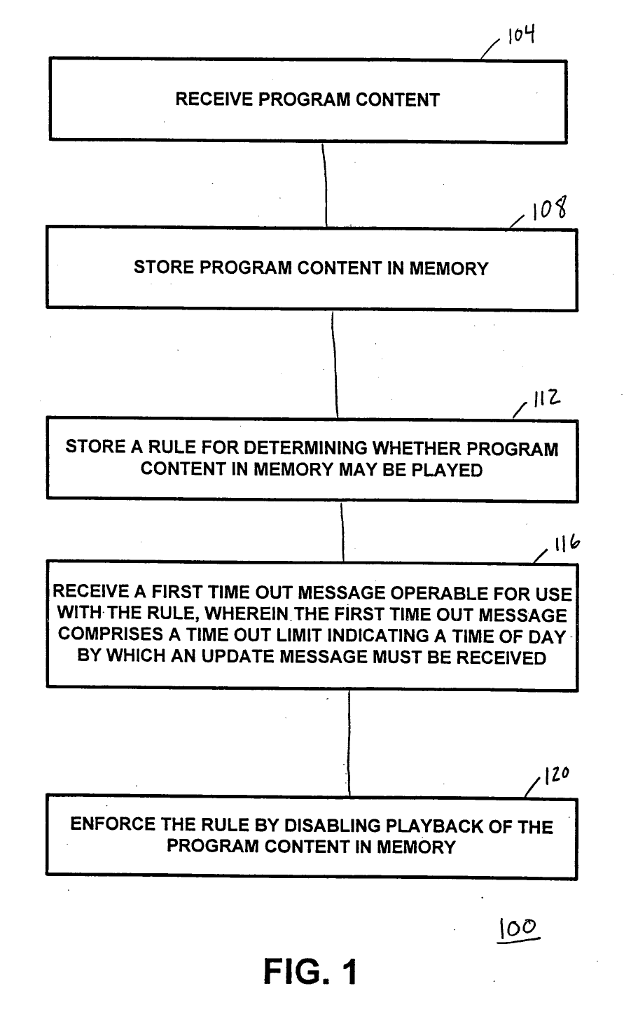

Referring to FIG. 1, a method can be used for preventing such an attack by a hacker according to one embodiment of the invention. Namely, FIG. 1 illustrates a flowchart 100 for implementing such a method. In block 104, the client or client system receives program content. This program content is stored in memory as illustrated by block 108. Reception of the contents can come via a network, such as a cable system or via the Internet. The program content can be downloaded directly to a memory at the client computer or stored remotely for access by the client computer. Block 112 illustrates that a rule for determining whether program content stored in memory may be played is stored in memory. Such a rule can be part of a rental agreement, for example, for program content downloaded via the Internet. In block 116, a first time out message is received that is operable for use with the rule. This first time out message can be comprised of a time out limit that indicates a specific time of day by which an update message must be received. Finally, in block 120, the rule can be enforced by disabling playback of the program content stored in memory.

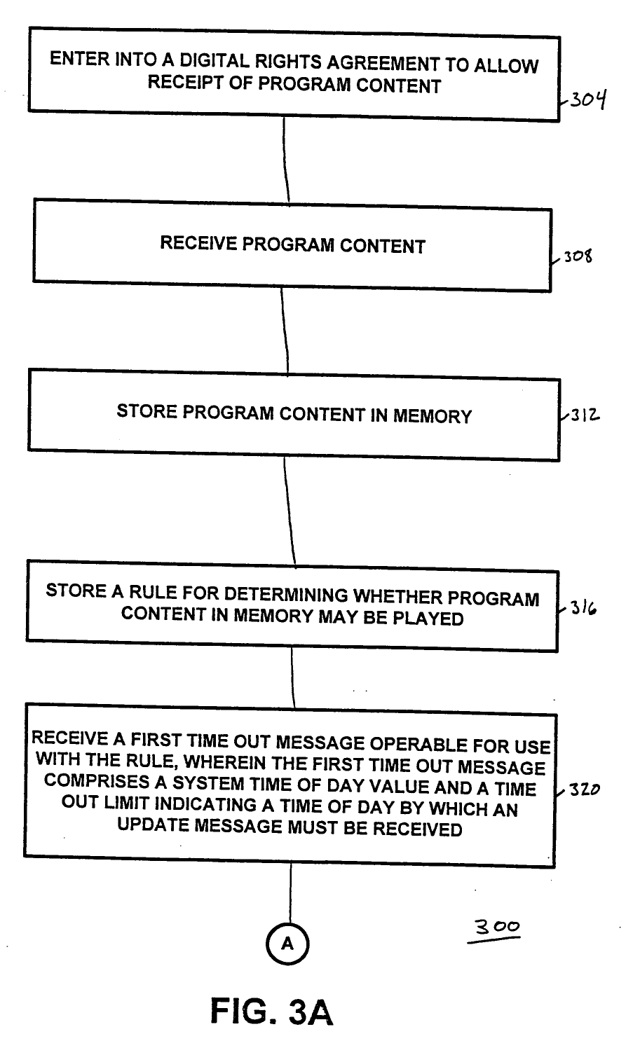

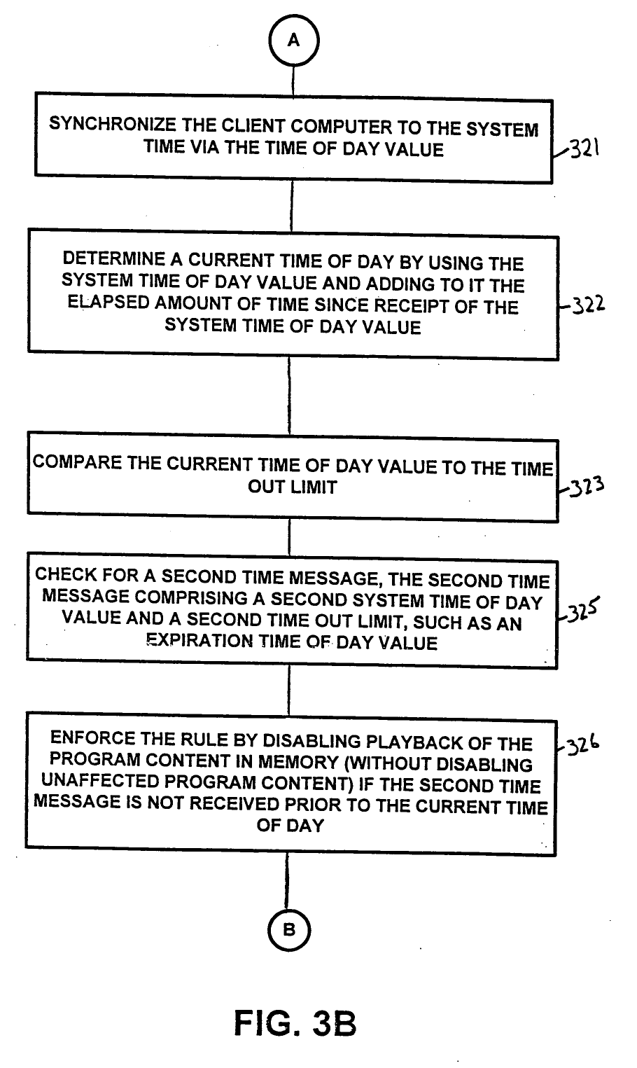

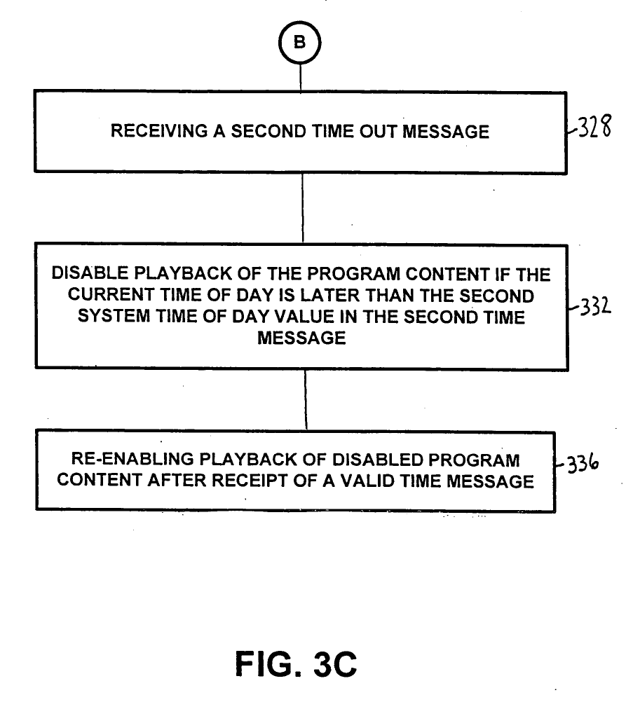

Referring now to FIGS. 3A, 3B, and 3C, a flowchart 300 for implementing yet another embodiment of the invention can be seen. FIG. 3A shows that a customer first enters into a digital rights agreement so as to receive program content. Such digital rights agreements can be entered into, for example, with cable companies or with individual distributors for renting program content. In block 308, the program content is distributed from the program distributor and received by the customer. This program content can then be stored in memory 312, such as on the customer's PC. Alternatively, it could be stored in a database remote from the client's computer.

In accordance with the digital rights agreement, a rule is downloaded to the customer system. This rule is typically downloaded after entering into the digital rights agreement. It could be downloaded as part of the distribution of the program content to the client's computer or separately. The rule is stored in memory and can be used to determine whether the program content may be played as shown in block 316. Use of the word played is intended to convey the idea of the client using program content. In block 320, a first time out message is distributed. This message is operable for use with the previously received rule. The first time out message can be comprised of a system time of day value and a time out limit indicating a time of day by which an update message must be received.

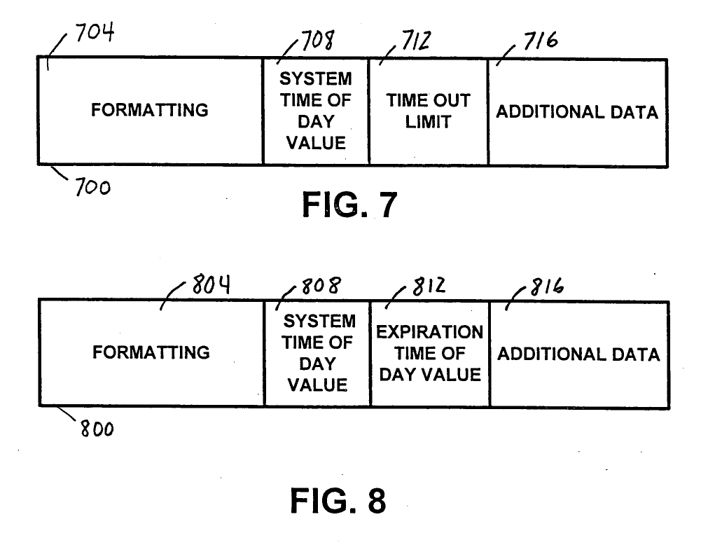

For example, a system time of day value can be a reliable time stamp indicating the time of day for a geographic region's time zone that is synchronized with Greenwich Mean Time. Alternatively, the system time of day value might be based on a time system unique to the distribution system. Thus, a distribution system can distribute time-restricted material and additionally download the system time of day value that is reliable for computing the time of use of the content. This system time is more reliable than a computer's clock in view of the fact that a computer's clock is reliant upon a crystal for determining what time it is and thus open to manipulation by a pirate. Similarly, some clocks are software based and are similarly unreliable. Thus, by receiving time out messages, each comprised of a system time of day value and a time out limit, the internal clock can be synchronized to the system time. Furthermore, the time out limit which is part of the first time out message can be used to indicate a time of day by which an update message must be received. In FIG. 7, an exemplary time out message can be seen. Message 700 includes formatting data 704, the system time of day value 708 and time out limit 712. Furthermore, the exemplary message includes additional data 716 for conveying further information.

In block 321, the client computer can be synchronized to the system time via the system time of day value received as part of the time out message. Thus, block 322 shows that a current time of day can be determined by using the system time of day value and adding to it the amount of time that elapses after receipt of the system time of day value. Thus, the clock of the client computer can be used to calculate a small portion of time after receipt of the system time of day value and then summing the two values. Consequently, block 322 shows that a current time of day can be determined by using the system time of day value and adding to it the elapsed amount of time since receipt of the system time of day value. This elapsed amount of time can be computed by the internal clock of the computer.

In block 323, the current time of day value is compared with the time out limit received as part of the first time out message. The time out limit is used to indicate a time by which an update must be received. The time out limit can be a specific time of day or, alternatively, a fixed block of time during which the accompanying system time message is deemed valid. Thus, after the time indicated by the time out limit, a new time out message must be received by the customer to prevent restriction of the program contents.

In block 325, a check for a second time out message is performed. Again, the second time out message is formatted similarly to the first time out message and can comprise a second system time of day value and a second time out limit. The time out limit value serves as an expiration value for the second time out message.

In block 326, the digital rights management rule is enforced. The rule is enforced by disabling playback of program content in memory if the second time message is not received so as to update the system time of day value prior to the computed current time of day. Thus, the customer computer receives the first time out message and uses the system time of day value and internal clock to compute the current time of day. It then checks whether the second time out message has been received. If no second message has been received and the current time of day is past the time out limit indicated in the first time out message, then the rule is enforced by disabling playback. Playback can be disabled by the system in a variety of ways. For example, it can disable all playback of all program content stored at the computer. Alternatively, it might only disable program content that is time restricted. Thus, non-time restricted program content could still be played. Alternatively, it might only restrict playback of a specific program without restricting playback of other programs. In disabling playback, the entire ability to use the program content might be disabled. Alternatively, the quality of the program content might only be diminished. Thus, for example, one might choose to display program video that is intermittently interrupted so as to be annoying to the viewer. Alternatively, one might create a smaller block of video that is difficult to see. Further, one might prevent playback of video, while allowing playback of sound. If program content concerns only sound content, then one might garble the sound intermittently or reduce the quality of the sound. All of these techniques are within the abilities of those of ordinary skill in the art.

In block 328, the second time out message is received. Again, a test is performed to determine whether the current time of day value is later than the second system time of day value which forms part of the second time out message. If the current time of day value is later than the second system time of day value in the second time out message, playback again is disabled. This helps prevent an attack where the attacker tries to buffer time messages and feed them to the processor close to the time out limit. If the attacker waits until after the time out limit, then the attack is thwarted.

In block 336 of method 300, playback of disabled program content can be reenabled. Once a valid time message is received, then restoration of the disabled program contents can be provided. Thus, one validity test might be whether the system time of day value indicated in the new time out message matches the current time of day computed by the client computer or represents a time of day later than the current time of day value computed by the client computer. Thus, flowchart 300 illustrates a defense to an attack in which an attacker fabricates or interferes with time messages.

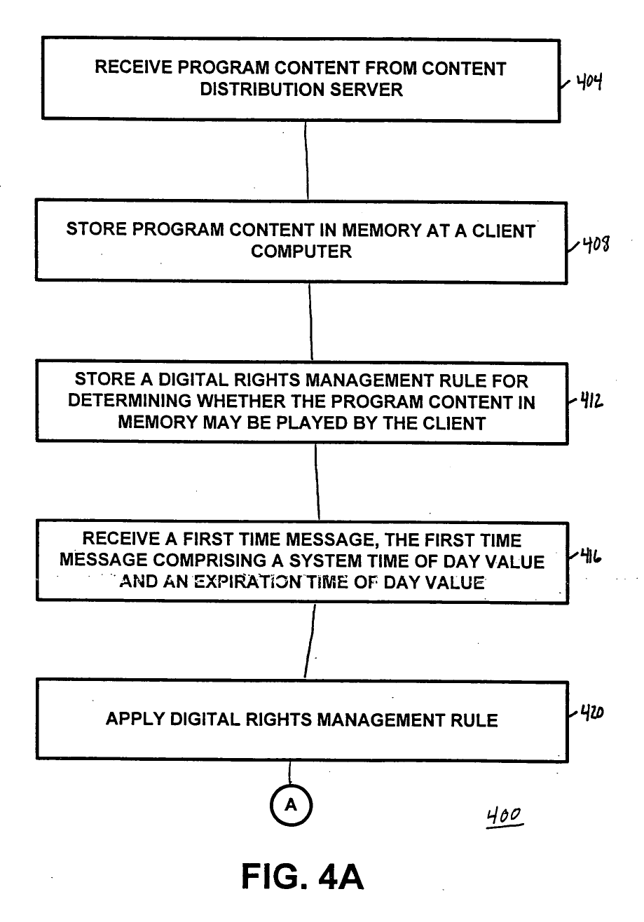

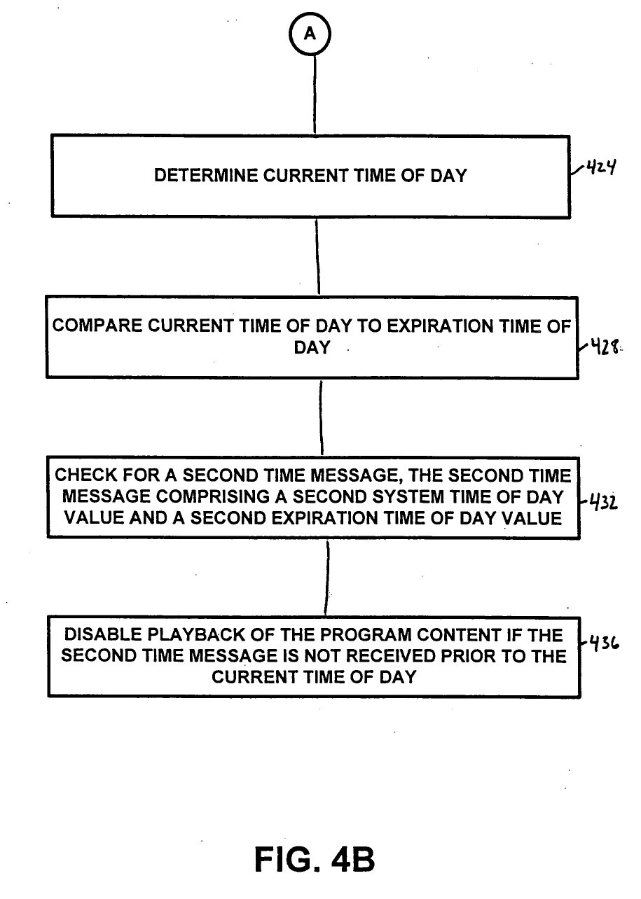

FIGS. 4A and 4B illustrate a flowchart 400 for implementing another embodiment of the invention. In block 404 of exemplary flowchart 400, program content is received from a content distribution server. This program content is stored in memory at a client computer as shown in block 408. A digital rights management rule for determining whether the program content in memory may be played by a client system is stored in block 412. A first time message is received in block 416. The first time message can be comprised of a system time of day value and an expiration time of day value. FIG. 8 illustrates an exemplary time message 800 comprising a system time of day value 808, an expiration time of day value 812, formatting 804, and additional data 816. In block 420, the digital rights management rule is applied. A current time of day is determined in block 424 and the current time of day is compared with the expiration time of day of the first time message in block 428. A check for a second time message is performed in block 432. The second time message is shown as comprised of a second system time of day value and a second expiration time of day value. If the second time message is not received prior to the first expiration time of day, playback of the program content is disabled, as shown by block 436. Thus, the embodiments taught by FIGS. 4A and 4B can be used to combat an attacker who attempts to buffer time messages. It is envisioned that with a system which transmits multiple time messages having a certain period of validity, that an attacker might attempt to buffer several messages and distribute them to the processor only at the point when the previous time message is about to expire. Thus, the attacker can gain additional time by delaying the distribution of the subsequent time messages to the processor. Thus, this embodiment can use a fixed time of day as the expiration time rather than a delta of time after the system time of day value.

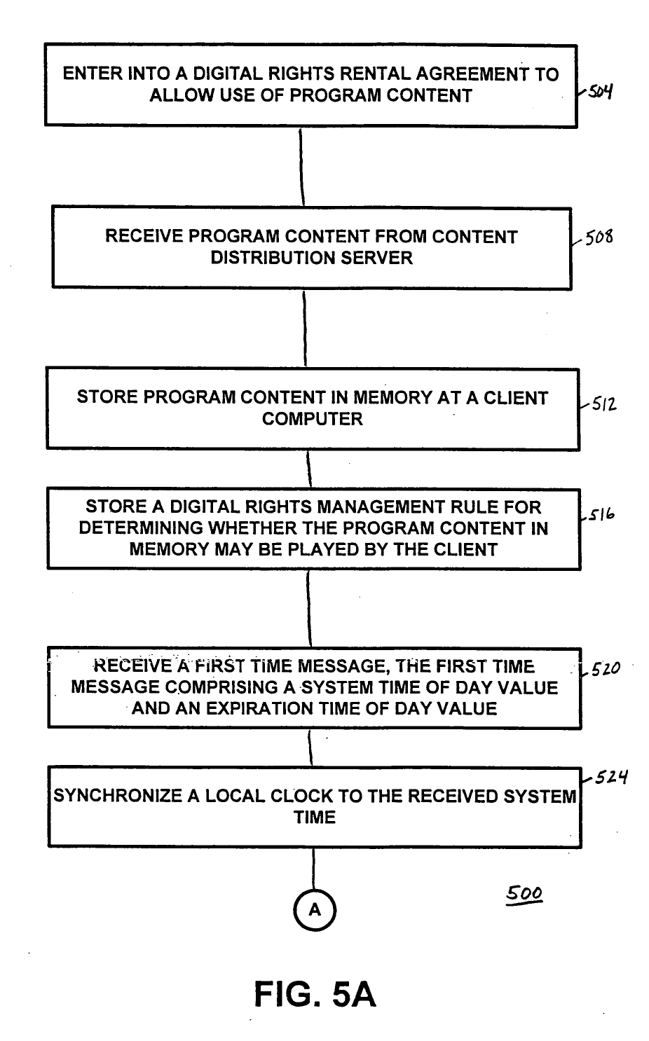

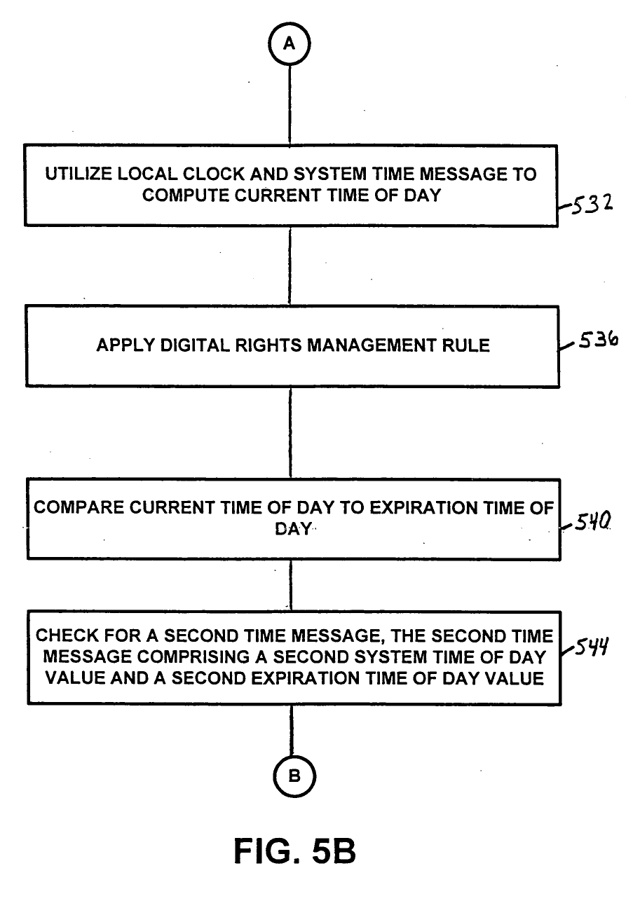

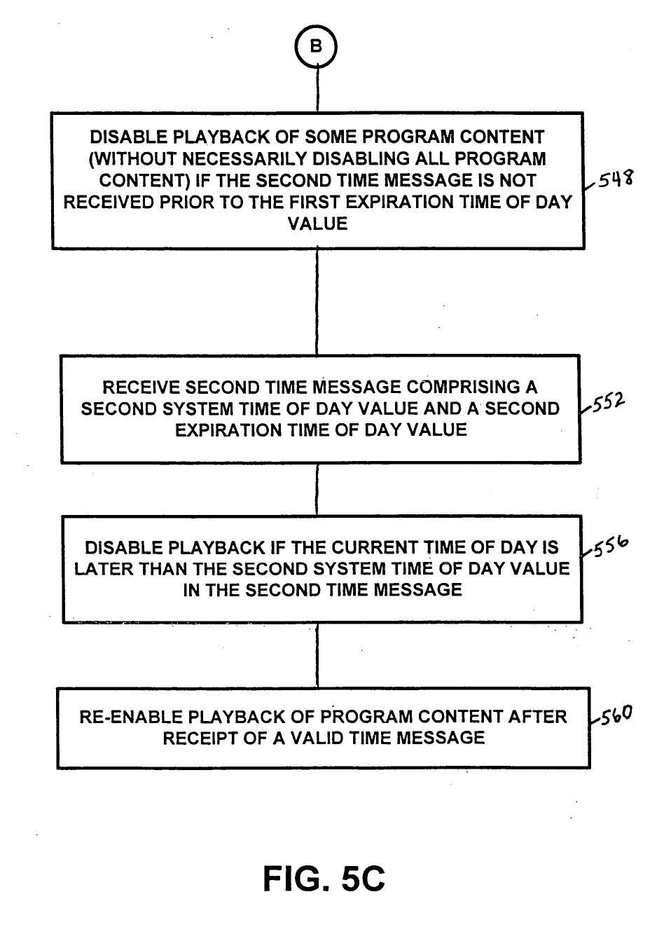

FIGS. 5A, 5B, and 5C illustrate yet another embodiment of the invention. In block 504 of flowchart 500, a customer enters into a digital rights rental agreement to allow use of program content. The customer receives the program content from a content distribution server in block 508. Program content is stored in memory, such as at the client computer as shown in block 512. Furthermore, a digital rights management rule for determining whether the program content may be played by the client is stored in memory at block 516. A first time message is received at the client system in block 520. The first time message is shown as comprised of a system time of day value and an expiration time of day value. The local clock of the client system is synchronized to the system time of day value received as part of the first time message, in block 524. In block 532, the local clock and system time of day value are utilized to compute a current time of day. Since the local clock has been synchronized to the system time of day value, it can increment to compute the current time of day. Alternatively, it can be used to indicate the amount of time expired since receipt of the first time message and be added to the system time of day value to compute the current time of day.

In block 536, the digital rights management rule is invoked and applied. To apply the digital rights management rule, the current time of day can be compared to the expiration time of day included as part of the first time message. This is shown in block 540. Thus, if the current time of day reaches a specific time value which is past the expiration time of day, the client system knows to disable the use of program content. By utilizing a fixed time of day, the client system can thwart the use of buffered messages.

In block 544, a check is made for receipt of a second time message. The second time message is shown as comprised of a second system time of day value and a second expiration time of day value. In block 548, playback of some program content is disabled if the second time message is not received prior to the first expiration time of day value.

In block 552, a second time message is received comprising a second system time of day value and a second expiration time of day value. If the current time of day is later than the second system time of day value in the second time message, then the second time message is deemed invalid. This is shown by block 556. Once a valid time message is received, playback of program content can be reenabled as shown by block 560.

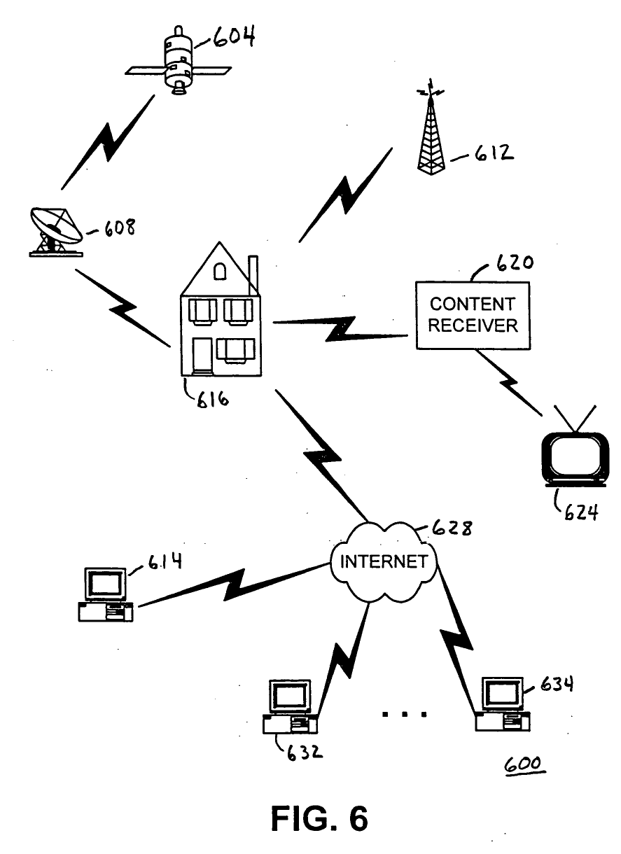

FIG. 6 illustrates a system suitable for distributing program content. In FIG. 6, a satellite 604 can transmit to a satellite receiver 608. The satellite receiver can then forward the received program content to content distributor 616. Such a program distributor might be a cable head end. Alternatively, the program content distributor might receive program content via transmitter 612 or via the Internet from server 614. The content distributor can then distribute the content to various clients. As one example, the content might be distributed over a cable system to a content receiver, such as a set-top box 620, and then displayed or listened to on a client's system, such as television 624. Alternatively, the content distributor might distribute the content to a client or a plurality of clients over the Internet, such as exemplary clients 632 and 634. Distribution via the Internet provides the ability to multicast to a large number of client computers and use the time messages in an efficient manner which does not require as much bandwidth as would be required in an interactive one-to-one distribution system.

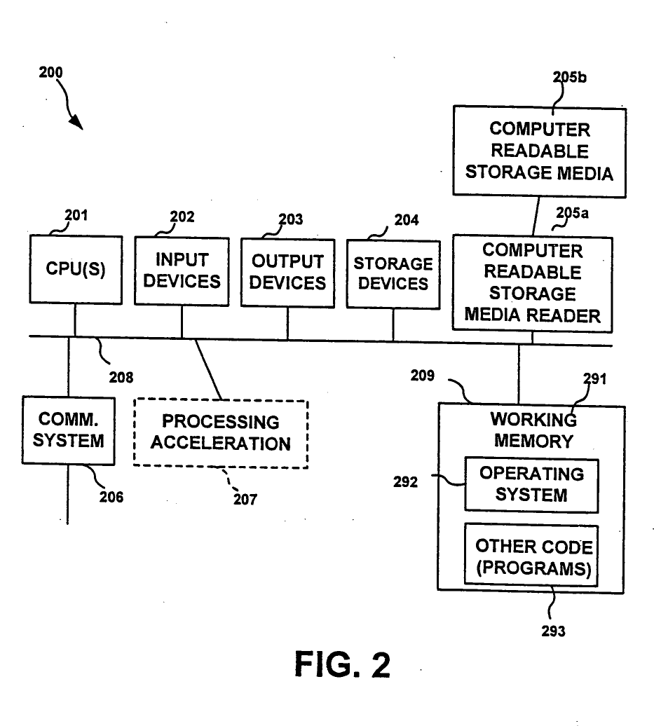

FIG. 2 illustrates a system for implementing a client based device. Furthermore, FIG. 2 is operable and suitable for use with the various computerized devices illustrated in FIG. 6. The device shown in FIG. 2 is further suitable for receiving the messages illustrated in FIGS. 7 and 8. For example, FIG. 2 broadly illustrates how individual system 600 elements can be implemented in a separated or more integrated manner within various, generally similarly configured processing systems. System 200 is shown comprised of hardware elements that are electrically coupled via bus 208, including a processor 201, input device 202, output device 203, storage device 204, computer-readable storage media reader 205a, communications system 206 processing acceleration (e.g., DSP or special-purpose processors) 207 and memory 209. Computer-readable storage media reader 205a is further connected to computer-readable storage media 205b, the combination comprehensively representing remote, local, fixed and/or removable storage devices plus storage media, memory, etc. for temporarily and/or more permanently containing computer-readable information, which can include storage device 204, memory 209 and/or any other such accessible system 200 resource. System 200 also comprises software elements (shown as being currently located within working memory 291) including an operating system 292 and other code 293, such as programs, applets, data and the like.

System 200 is desirable as an implementation alternative largely due to its extensive flexibility and configurability. Thus, for example, a single architecture might be utilized to implement one or more servers that can be further configured in accordance with currently desirable protocols, protocol variations, extensions, etc. However, it will be apparent to those skilled in the art that substantial variations may well be utilized in accordance with more specific application requirements. For example, one or more elements might be implemented as sub-elements within a system 200 component (e.g. within communications system 206). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) and not all system 200 components will be required in all cases.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents, including the matter incorporated by reference.

It is thought that the apparatuses and methods of the embodiments of the present invention and its attendant advantages will be understood from this specification. While the above is a complete description of specific embodiments of the invention, the above description should not be taken as limiting the scope of the invention as defined by the claims.

1. A method of controlling use of program content, said method comprising:
receiving program content;
storing said program content in memory;
storing a rule for determining whether said program content in memory may be played;
receiving a first time out message operable for use with said rule, wherein said first time out message comprises a time out limit indicating a time of day value by which an update message must be received;
enforcing said rule by disabling playback of said program content in memory.

2. The method as described in claim 1 wherein said disabling playback of said program content comprises reducing the quality of the playback of the program content.

3. The method as described in claim 1 wherein said first time out message comprises a system time of day value.

4. The method as described in claim 3 and further comprising:
synchronizing a client computer to said system time via said system time of day value in said first time out message.

5. The method as described in claim 1 and further comprising:
determining a current time of day.

6. The method as described in claim 3 and further comprising:
determining a current time of day using said system time of day value and a local clock of the client computer.

7. The method as described in claim 1 wherein said enforcing said rule comprises:
determining a current time of day;
comparing said current time of day to said time out limit;
checking for a second time out message, said second time out message comprising a second system time of day value and a second time out limit;
disabling playback of said program content if said second time out message is not received prior to said time out limit.

8. The method as described in claim 1 and further comprising:
receiving a second time message;
re-enabling playback of said program content after receipt of said second time out message.

9. The method as described in claim 1 and further comprising:
entering into a digital rights rental agreement to allow receipt of said program content.

10. The method as described in claim 1 wherein said disabling playback comprises:
disabling playback of some program content while not disabling playback of other program content.

11. The method as described in claim 3 and further comprising:
synchronizing a local clock to a system clock by utilizing said time of day value.

12. The method as described in claim 3 and further comprising:
utilizing a local clock and said system time of day value to compute a current time of day.

13. The method as described in claim 1 and further comprising:
receiving a second time out message comprising a second system time of day value;
disabling playback if the current time of day is later than the second system time of day value in the second time out message.

14. An apparatus for controlling use of program content, said apparatus comprising:
a receiver operable for receiving program content from a content distributor;
a memory for storing said program content;
code operable for implementing a rule for determining whether said program content in memory may be played;
a processor coupled with said memory;
code operable for enforcing a rule coupled to said apparatus wherein said rule disables playback of said program content if a time out message is not received prior to a time of day value indicated by a previous time out message.

15. A method of controlling use of program content, said method comprising:
receiving program content from a content distribution server;
storing said program content in memory coupled to client computer;
storing a digital rights management rule for determining whether said program content in memory may be played by said client;
receiving a first time message, said first time message comprising a system time of day value and an expiration time of day value;
applying said digital rights management rule, wherein said applying comprises:
determining a current time of day;
comparing said current time of day to said expiration time of day;
checking for a second time message, said second time message comprising a second system time of day value and a second expiration time of day value;
disabling playback of said program content if said second time message is not received prior to said expiration time of day value.

16. The method as described in claim 15 wherein said disabling playback comprises reducing the quality of the playback of said program content.

17. The method as described in claim 15 and further comprising:
receiving said second time message;
re-enabling playback of said program content after receipt of said second time message.

18. The method as described in claim 15 and further comprising:
entering into a digital rights rental agreement to allow use of the program material.

19. The method as described in claim 15 wherein said disabling playback comprises:
disabling playback of some program content while not disabling playback of other program content.

20. The method as described in claim 15 and further comprising:
synchronizing a local clock to a system clock.

21. The method as described in claim 15 and further comprising:
utilizing a local clock and a system time message to compute a current time of day.

22. The method as described in claim 15 and further comprising:
disabling playback if the current time of day is later than the second system time of day value in the second time message.

23. An apparatus for controlling use of program content, said apparatus comprising:
a receiver for receiving program content from a content distribution server;
memory for storing said program content;
code operable for applying a digital rights management rule, wherein said code for applying said rule comprises:
code operable for determining a current time of day;
code operable for comparing said current time of day to an expiration time of day value received in a first time message, said first time message comprising said expiration time of day value and a system time of day value;
code operable for checking for a second time message, said second time message comprising a second system time of day value and a second expiration time of day value;
code operable for disabling playback of said program content if said second time message is not received prior to said expiration time of day value.
